(19) United States
(12) Patent Application Publication
(10) Pub. No.: US 2021/0122073 A1
(43) Pub. Date: Apr. 29, 2021

(54) Safety Razor with Visually Identifiable Blade

(71) Applicant: Bob Barker Company, Inc., Fuquay-Varina, NC (US)

(72) Inventor: Erin Paige Howell, Angier, NC (US)

(21) Appl. No.: 17/143,688

(22) Filed: Jan. 7, 2021

Related U.S. Application Data
(63) Continuation of application No. 15/915,532, filed on Mar. 8, 2018.
(60) Provisional application No. 62/472,662, filed on Mar. 17, 2017.

(51) Int. Cl. B26B 21/60; B26B 21/06; B26B 21/40

(52) U.S. Cl. CPC B26B 21/60; B26B 21/4012; B26B 21/06

(57) ABSTRACT

The present application is directed to a razor for use in an institutional facility. The razor includes a translucent housing and a blade within the housing. The blade has one or more visually identifiable visual aspects such that the blade can be recognized during a visual inspection of the razor. The razor can also include one or more additional blades. These blades can also include one or more visual aspects.

### RELATED APPLICATIONS

This application is a continuation of application Ser. No. 15/915,532, filed Mar. 8, 2018 which claims the benefit of U.S. Provisional Application No. 62/472,662, filed Mar. 17, 2017, the disclosures of which are incorporated herein by reference in their entireties.

### BACKGROUND

Individuals in institutional facilities such as jails, mental health facilities, rehabilitation facilities, juvenile facilities, and detention centers are provided with a variety of products that are used in their everyday life. One product is a razor. The razor generally includes a handle, a housing, and one or more blades positioned in the housing.

Razors for use in institutional facilities should include safety measures to prevent individuals from tampering with the razors to use them as a weapon. This can include removing the one or more blades and using them as a weapon to harm others and/or themselves.

The razors should also be constructed to provide for personnel working at the institution to visually inspect the razors and determine if there has been tampering. This provides for the personnel to visually determine that there is an issue and take the necessary steps to prevent any injuries. The construction also acts as a deterrent to prevent the individuals from tampering with the razors.

### SUMMARY

The present application is directed to a razor for use in an institutional facility. The razor may include a translucent housing and a blade within the housing. The blade has one or more visually identifiable visual aspects such that the blade can be recognized during a visual inspection of the razor. The razor can also include one or more additional blades that can also include one or more visual aspects.

One aspect is directed to a razor that includes a handle and a housing at an end of the handle with the housing having one or more translucent sections. A first blade is positioned within the housing and includes flat front and back faces and a cutting edge between the front and back faces. The first blade is positioned with the cutting edge extending from the housing. Visual aspects are positioned on at least one of the front and back faces. The visual aspects are positioned at the one or more translucent sections to be visible through the housing. The visual aspects are selected from the group consisting essentially of color, characters, and texture.

The razor may include the first blade constructed from a material with a first color, and the visual aspect may be a color that is different than the first color.

The razor may include a first visual aspect including a first area with a first color and a second visual aspect including a second area different than the first area with a different second color.

The razor may include the visual aspects including a first character that is an alphanumeric character and a second character that is a non-alphanumeric character.

The razor may include that the entire housing is translucent.

The razor may include a second blade positioned within the housing and including flat front and back faces and a cutting edge between the front and back faces. The second blade may be positioned in an overlapping orientation with the first blade with the second blade being partially offset from the first blade with the cutting edge and a limited section of the front face of the second blade extending outward beyond the cutting edge of the first blade when viewed through a top of the housing. The front face of the second blade may include at least one of the visual aspects just on the limited section.

The razor may include one or more visual aspects on the back face of the second blade.

The razor may include the first blade having visual aspects on just the front face.

The razor may include that the visual aspects on the first blade are different than the visual aspects on the second blade.

Another aspect is directed to a razor with a handle and a housing on the handle and having a slot and having one or more translucent sections. A blade is positioned within the housing and has a cutting edge that extends through the slot and with the blade being constructed from a material having a first color. At least two color areas are on the blade are aligned with the one or more translucent sections of the housing and with each of the color areas having a different color.

The razor may include the color areas positioned on just one face of the blade.

The razor may include a front face of the blade with at least two of the color areas and a back face of the blade with at least two of the color areas.

The razor may include an entirety of the housing being translucent.

The razor may include at least one character on the blade that may be positioned at the one or more translucent sections to be visible through the housing.

The razor may include that the color areas are away from the cutting edge.

Another aspect is directed to a razor having a handle and a housing at an end of the handle. The housing includes a first translucent section on a first side and a second translucent section on a second side. First and second blades are positioned within the housing and each of the first and second blades includes a cutting edge that extends from the housing. At least one visual aspect is positioned on each of the first and second blades and is aligned with at least one of the translucent sections. The visual aspects include one or more characters and colors, with the colors being different than a color of a material of the blade. The first and second blades are positioned in an overlapping and offset orientation with just a limited section of the second blade visible through the first side of the housing and with the visual aspect positioned on the limited section of the second blade and away from the cutting edge.

The razor may include that just a limited section of the first blade is visible through the second side of the housing and with at least one visual aspect positioned on just the limited section and away from the cutting edge.

The razor may include a slot in the housing with each of the first and second cutting edges extending through the slot.

The razor may include that the at least one visual aspect on the first blade is different than the at least one visual aspect on the second blade.

The razor may include that the at least on visual aspect on the first blade is a first color and the at least one visual aspect on the second blade is a different second color.

Another embodiment is directed to a razor that includes a handle, a translucent housing mounted at the end of the handle and having a slot, and a blade positioned within the housing. The blade includes a cutting edge that extends through the slot and is exposed. The blade is constructed from a material having a first color. The blade includes a surface area with at least one color that is different than the first color. The surface area is positioned relative to the translucent housing to be visually identifiable from an exterior of the housing.

The surface area may include one color that is different than the first color.

The surface area may include a pattern of at least two colors.

The surface area may include a second color that extends over a first section of the surface area and a third color that extends over a second section of the surface area.

The surface area with the one or more identifiable aspects may be positioned away from the cutting edge of the blade.

The surface area may extend along both front and back sides of the blade.

The surface area may extend around holes that extend through the blade.

Another embodiment is directed to a razor that includes a handle, a translucent housing mounted at the end of the handle, and a blade positioned within the housing. The blade includes a cutting edge that extends from the housing, and flat front and back faces. The blade has an area that extends over at least one of the front and back faces. The area includes a visually identifiable aspect that is visually different than the front and back faces. The area is positioned relative to the translucent housing to be visually identifiable from an exterior of the housing.

The blade may be constructed from a material with a first color, and the visually identifiable aspect may be a color that is visually different than the first color.

The front and back faces may be flat, and the visually identifiable aspect may be texture.

The various aspects of the various embodiments may be used alone or in any combination, as is desired.

### BRIEF DESCRIPTION OF THE DRAWINGS

FIG. 1 is a front view of a razor.

FIG. 2 is a plan view of a blade with color as a visual aspect.

FIG. 3 is a front view of a blade with color as the visual aspect and being positioned in a translucent housing.

FIG. 4 is a plan view of a blade with visual aspects being color.

FIG. 5 is a plan view of a blade with visual aspects being color.

FIG. 6 is a plan view of a blade with visual aspects being color.

FIG. 7 is a plan view of a blade with visual aspects being characters on the blade.

FIG. 8 is a plan view of a blade with visual aspects being characters on the blade.

FIG. 9 is a plan view of a blade with visual aspects being indents on the blade.

FIG. 10 is a plan view of a blade with a combination of visual aspects.

FIG. 11 is a plan view of a blade with a combination of visual aspects.

FIG. 12 is a top view of a razor with a housing having a pair of translucent sections.

FIG. 13A is a top view of a razor having a pair of blades positioned in a housing.

FIG. 13B is a bottom view of the razor of FIG. 12A with the handle not illustrated for clarity.

FIG. 14 is a plan view of the first blade of the razor of FIGS. 12A and 12B.

### DETAILED DESCRIPTION

The present application is directed to a razor that includes one or more blades that are visually identifiable from an exterior of the razor. The blade is configured such that a visual inspection can confirm that the blade is located in the razor and has not been removed or tampered with.

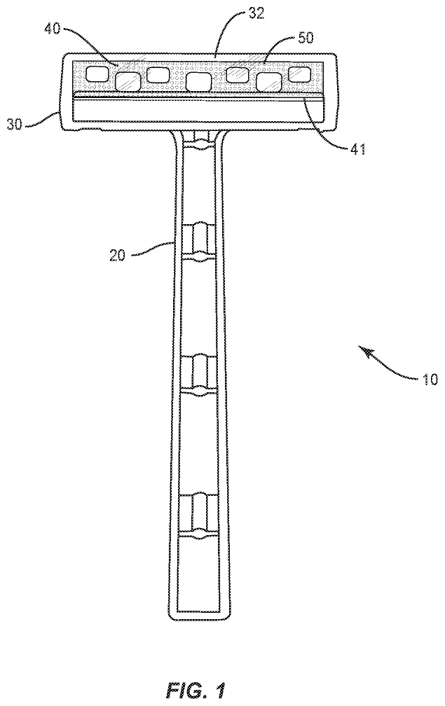

FIG. 1 illustrates a razor 10 for use in an institutional environment. The razor 10 includes a handle 20 and a housing 30. The housing 30 includes one or more translucent sections 32. The translucent sections 32 can include the entire housing 30, a portion of the housing 30 such as the top or bottom, or discrete windows that extend across a limited area of the housing 30. A blade 40 is positioned in the housing 30. An edge 41 of the blade 40 is exposed outside of the housing 30 such that it can be used for shaving the user. The blade 40 is visible through the one or more translucent sections 32 of the housing 30 to allow for visual inspection. The blade 40 includes one or more visual aspects 50 that are visible such that an inspector is able to visually determine that the blade 40 is properly positioned in the housing 30.

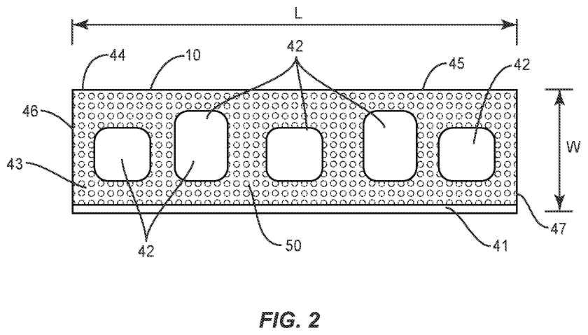

FIG. 2 illustrates a blade 40 removed from the housing 30. The blade 40 includes a flattened shape with opposing first and second flat faces 43, 44. A sharpened cutting edge 41 extends along the edge between the first and second faces. The blade 40 includes a width W measured between the cutting edge 41 and an opposing edge 45. The blade 40 also includes a length L measured between ends 46, 47. The blade 40 is constructed from a metal such as but not limited to high carbon steel and stainless steel. The metal has a color, usually grey, silver, or the like.

The blade 40 further includes one or more holes 42 that extend through the blade. The holes 42 can be configured to facilitate installation and/or engage with the housing 30 and secure the blade 40. The holes 42 can include the same size and shape, or may include multiple sizes and/or shapes. The holes 42 can be aligned in a straight line across the length of the blade 40 as illustrated in FIG. 2. Other embodiments include a blade 40 with the holes 42 not being aligned in a straight line across the length, blades 40 with a single hole 42, and blades 40 with no holes 42.

The blade 40 includes one or more visual aspects 50 that are visible through the one or more translucent sections 32 of the housing 30 during a visual inspection of the razor 10. In one embodiment, the visual aspect 50 is a distinct color that extends over an area of the blade and visually differentiates the blade 40 from the housing 30.

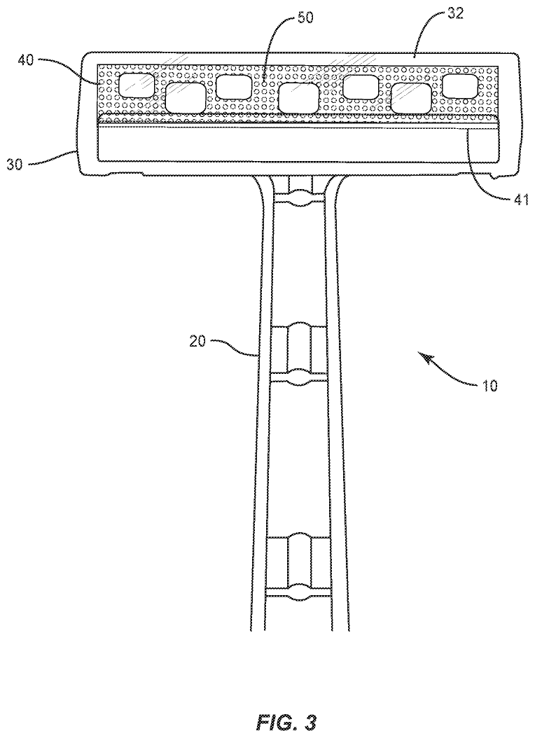

The color may be bright and have a high intensity. This may include natural colors with a high intensity such as red, yellow, and orange. This may also include neon and fluorescent colors that contain chemical additives to create unnatural levels of intensity. The color that is added to the blade 40 is different than the color of the blade material. One color includes a bright green color that is markedly different than the color of the blade material. Other colors include but are not limited to yellow, orange, and red. FIG. 3 illustrates a colored blade 40 mounted in the housing 30 of the razor 10. The blade 40 is visible through the one or more translucent sections 32 of the housing 30 such that it is visually identifiable.

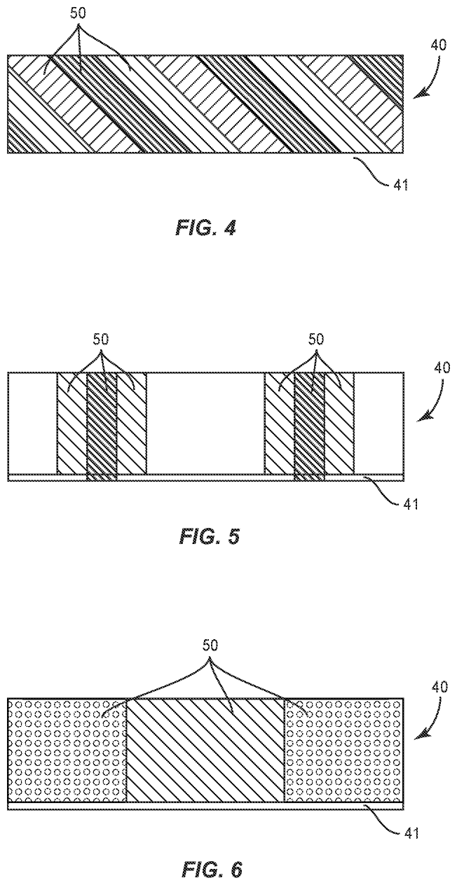

The aspects 50 can also include combinations of colors. FIG. 4 includes multiple colors that are aligned in diagonal rows across the length of the blade 40. FIG. 5 includes sets of color bands 50 extending across a majority of the height of the blade 40. FIG. 6 includes different-colored sections 50.

The blade 40 can be colored in a variety of different manners. This can include a coating that is applied to the blade 40. The coating can include a painted coating or a chemical coating. The color can also be achieved through various processes, such as but not limited to spraying, and chemical and electrochemical techniques such as plating. One embodiment includes an ink stamping process to apply the color.

The sized of the area that includes the color can vary. The color area can extend over an entirety of the blade 40. The color area can be located on the cutting edge 41, or can be spaced away from the cutting edge 41. The area can also be limited to one or more discrete sections on the blade 40 that may or may not include the cutting edge 41.

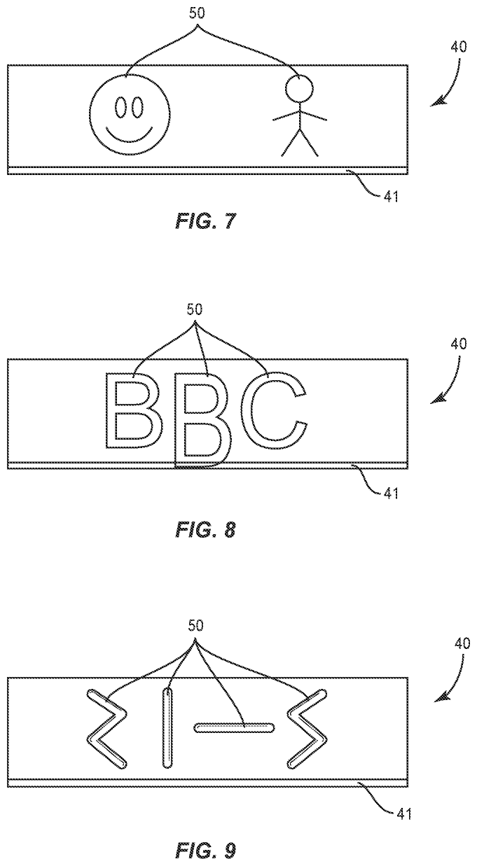

Another visually aspect 50 is indicia on the identifiable area of the blade 40. This can include characters 50 such as but not limited to specific words, letters, numbers, phrases, codes or other like identifiable aspect. FIG. 7 includes a pair of symbols 50 and FIG. 8 includes a series of letters 50. The number and spacing of the characters can vary. The characters 50 can be located on the cutting edge 41, or can be spaced away from the cutting edge 41.

Another identifiable aspect 50 includes texture that is visible on the surface of the blade 40. The texture 50 can include one or more ribs or knurled surface on a portion or majority of the blade 40. FIG. 9 includes raised ribs 50 that extend upward above a flat surface of the blade 40.

The one or more visual aspects 50 can be positioned on one or both of the first and second faces 43, 44. The visual aspects 50 can extend across an entirety of the first and/or second faces 43, 44, or limited sections of the first and/or second faces 43, 44. The one or more visual aspects 50 can be located on the cutting edge 41 or can be spaced away from the cutting edge 41. FIG. 2 includes an embodiment in which the color 50 extends along the entirety of the first face 43 of the blade 40 except for the cutting edge 41. This embodiment can also include the color 50 extending in a similar manner on the second face 44.

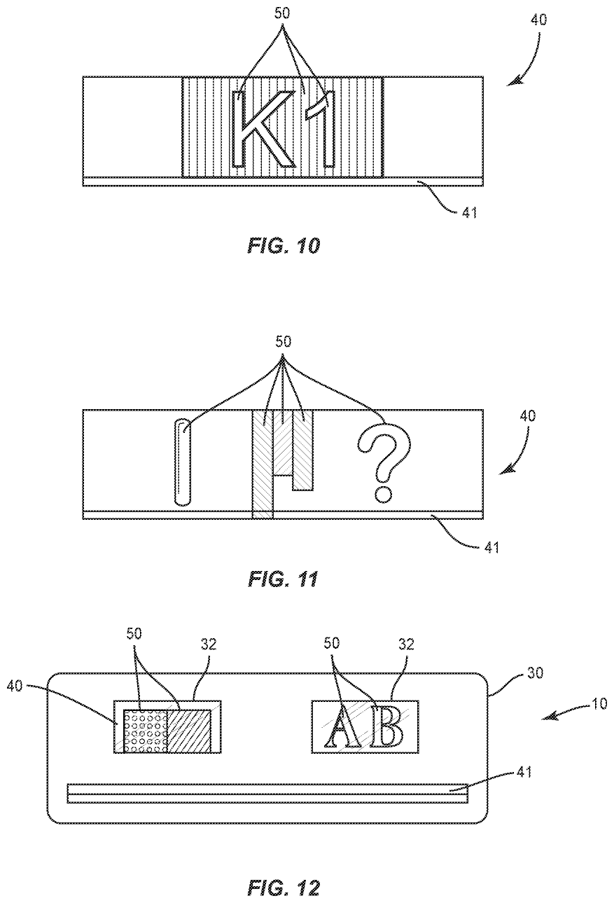

Combinations of different visual aspects 50 can also be included in the blade 40. This can include but is not limited to two or more colors, characters, and textures. FIG. 10 includes a blade 40 with a pair of alphanumeric characters 50 (i.e., K, 1) overlapping with a color 50. FIG. 11 includes a combination of an indented line 50, a set of three color stripes 50, and an alphanumeric character 50. With combinations, the different visual aspects 50 can include the same or different sizes. The one or more visually-identifiable aspects 50 can be horizontally or vertically aligned across the blade 40.

The one or more aspects 50 are sized and positioned to be visually identified by a viewer, such as a person that works at the institution (e.g., security guard). In one embodiment, the one or more aspects 50 are sized to extend across a distance at least one-half (½) of the width W. This provides a size that allows for visual recognition from a distance away from the blade 40.

In some embodiments, the one or more visually-identifiable aspects 50 can be spaced away from the cutting edge 41 of the blade 40. This prevents the aspects 50 from potentially interfering with the ability of the blade 40 to shave the user. Other embodiments include the one or more visually-identifiable aspects 50 being located on the cutting edge 41.

The one or more visual aspects 50 can be positioned on a single face 43, 44, or can be positioned on both faces 43, 44. In razors 10 in which the one or more translucent sections 32 of the housing 30 have a limited size, the one or more visual aspects 50 can be limited to just the section of the blade 40 that is observable through the translucent sections 32. In razors 10 having a housing 30 that is more extensively translucent (e.g., a top or bottom of the housing 30 being translucent or an entirety of the housing 30 being translucent), the one or more visual aspects 50 can be positioned on more area of the blade 40, including for example on both faces 43, 44.

FIG. 12 includes a housing 30 with a pair of translucent sections 32. Visual aspects 50 are positioned on the blade 40 to be visible from the exterior. In this embodiment, a first set of visual aspects 50 is positioned at one of the translucent sections 32 and a second set of visual aspects 50 is positioned at another translucent section 32. The housing 30 can include a variety of configurations that includes one or more translucent sections 32.

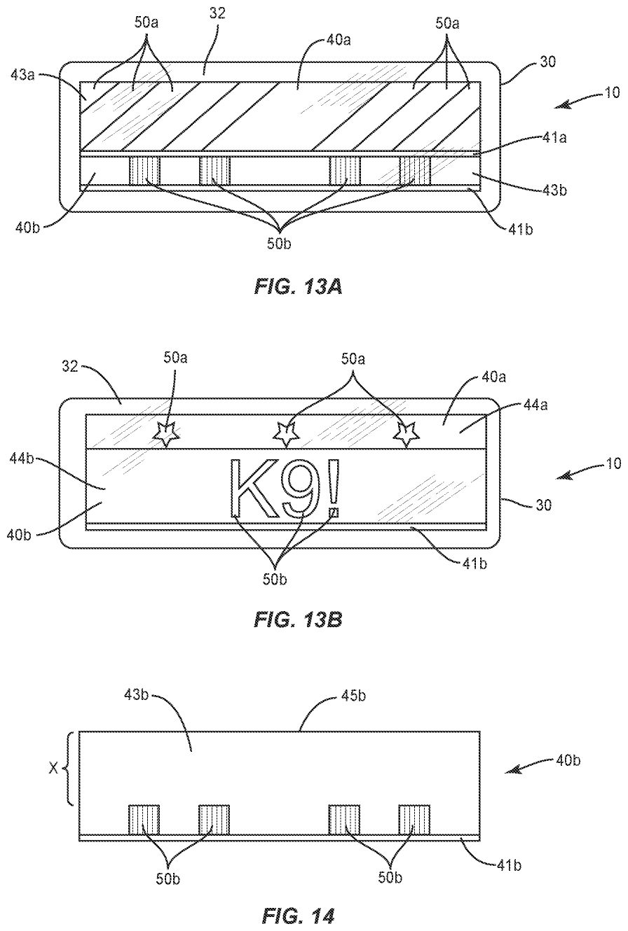

The razor 10 can also include two or more blades 40. FIG. 13A illustrates a razor 10 with a pair of blades 40a, 40b positioned in the housing 30. Each of the blades 40a, 40b includes a cutting edge 41a, 41b. The blades 40a, 40b are in an overlapping arrangement with each of the cutting edges 41a, 41b extending outward from the housing 30 to shave the user.

Each of the blades 40a, 40b includes one or more visual aspects 50a, 50b that are aligned with the one or more translucent sections 32 of the housing 30. In this embodiment, the entire housing 30 is translucent. The visual aspects 50a on the first blade 40a can extend across the front face 43a as it is exposed and visible through the housing 30. The visual aspects 50b on the second blade 40b can be limited to just the portion of the front face 43b that extends outward beyond the first blade 40a and is away from the cutting edge 41b. FIG. 14 illustrates the second blade 40b removed from the razor. The aspects 50b are in located along just the exposed portion of the face 43b. A section X of the face 43b does not include visual aspects 50b because it is overlapped by the first blade 40a and therefore is not visible.

The positioning of the visual aspects 50a, 50b can be reversed on the back side of the razor 10 as illustrated in FIG. 13B (for purposes of clarity, the handle 20 is not illustrated). The second face 44b of the second blade 40b can be visible through the housing 30. One or more visual aspects 50b can be positioned along the face 44b away from the cutting edge 41b. A limited portion of the second face 44a of the first blade 40a is visible. Visual aspects 50a on the second face 44a can be limited to just this limited portion.

With multiple blades 40, the visual aspects 50 can be different on the different blades 40 to provide a relative visual distinction. For example, a first blade 40a can include a first color aspect 50a and the second blade 40b can include a different second color aspect 50b. The different colors can be selected to better detect the two blades 40a, 40b. Likewise, one or more characters 50a on a first blade 40a can have a different visual appearance than characters 50b on a second blade 40b (e.g., alphanumeric characters of the first blade 40a and stick figure characters on the second blade 40b). This difference assists in the viewer to determine that both blades 40a, 40b are present. Further, a first blade 40a can include a first type of visual aspects 50 (e.g., one or more colors) and a second blade 40b can include a different second type of visual aspect 50 (e.g., characters). Other embodiments include the visual aspects 50 being the same on each of the blades 40.

The razor 10 includes one or more blades 40 that are positioned in the housing 30. The handle 20 extends outward from the housing 30. The handle 20 and housing 30 can be constructed as a single integral piece, or can be constructed from multiple pieces. If the housing 30 is a separate piece, it can be attached to the handle 20 in a variety of manners, including but not limited to adhesives, mechanical fasteners, and ultrasonic welding. The handle 20 and housing 30 can be constructed from a variety of different materials, including but not limited to thermoplastic rubber and plastics such as polycarbonate.

The blade 40 is positioned in and protected by the housing 30. The housing 30 extends around the blade 40 such that just the one or more cutting edges 41 are exposed. The housing 30 includes a slot that extends along the length through which the one or more cutting edges 41 extend for shaving the user. The housing 30 can extend around the remainder of the blade 40. The housing 30 includes the one or more translucent sections 32 for visual identification of the blade 40. The housing 30 can be constructed from multiple different pieces that are connected together to extend around the one or more blades 40.

The housing 30 is constructed at least in part from a translucent material to facilitate inspection of the one or more blades 40. The entire housing 30 can be translucent. Other embodiments include one or more limited sections 32 of the housing 30 being translucent. In one specific embodiment, the housing 30 is constructed from front and back sections with the translucent section 32 being just one of the front and back sections. In another specific embodiment, the housing 30 is constructed from front and back sections that are both translucent.

The identifiable blade 40 prevents a user from tampering with the razor 10. In the event one or more of the blades 40 are removed, the visual inspection indicates that the one or more blades 40 are missing from the housing 30. Further, in the event that the user removes the one or more blades 40 and attempts to replace it with another object (e.g., tin foil, cardboard), the visual inspection will allow the inspector to recognize that the one or more blades 40 have been replaced.

The one or more aspects 50 can include an appearance that is difficult for a person in the institution to reproduce. This prevents or lessens the likelihood that the person can remove the blade 40 and attempt to replace it with a dummy blade, such as one made from paper, tin foil, or other material that visually resembles the blade 40. A difficult to reproduce visual appearance makes it difficult for a user to reproduce a similar dummy blade and also assists in institution personnel to visually detect a fake blade.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A razor comprising:
a handle;
a housing at an end of the handle; and
a blade positioned within the housing and comprising front and back faces and a cutting edge between the front and back faces, the blade positioned with the cutting edge extending from the housing; and
a visual indicator attached to the front face of the blade and extending across the front face and away from the cutting edge, the visual indicator comprising a different appearance from the blade;
the housing configured for the visual indicator to be visible from an exterior of the housing.

2. The razor of claim 1, wherein the blade comprises a first color and the visual indicator comprises a second color that is different than the first color.

3. The razor of claim 2, wherein the visual indicator comprises a single color.

4. The razor of claim 1, wherein the blade comprises a single cutting edge.

5. The razor of claim 1, wherein the housing comprises a slot with the cutting edge extending through the slot.

6. The razor of claim 1, wherein the blade comprises holes that extend through the front and back faces and away from the cutting edge with the visual indicator extending around the holes.

7. A razor comprising:
a handle;
a housing on the handle and forming an interior section and having a slot, the housing being transparent for visual inspection of the interior section of the housing;
a blade positioned within the housing and having a face and a cutting edge, the blade constructed from a material having a first color; and
a visual indicator attached to the blade and extending across an entirety of the face and away from the cutting edge, the visual indicator comprising a second color that is different than the first color.

8. The razor of claim 7, wherein the face is a first face and the blade further comprises an opposing second face with the visual indicator spaced away from the second face.

9. A razor comprising:
a handle;
a transparent housing at an end of the handle;
a blade positioned within the housing and comprising front and back faces and a cutting edge between the front and back faces; and
a visual indicator attached to the front face of the blade and extending across an entirety of the front face and away from the cutting edge, the visual indicator comprising a different visual appearance from the blade.

10. The razor of claim 9, wherein the front and back faces of the blade are flat.

11. The razor of claim 9, further comprising a slot in the housing with each of the cutting edge extending through the slot.
